(19) United States
(12) Patent Application Publication
(10) Pub. No.: US 2022/0034996 A1
(43) Pub. Date: Feb. 3, 2022

(54) PIPELINED FFT WITH LOCALIZED TWIDDLE

(71) Applicant: Metawave Corporation, Carlsbad, CA (US)

(72) Inventor: Andreas FALKENBERG, Escondido, CA (US)

(21) Appl. No.: 17/393,262

(22) Filed: Aug. 3, 2021

Related U.S. Application Data
(60) Provisional application No. 63/060,538, filed on Aug. 3, 2020.

(51) Int. Cl. G01S 7/35; G06F 17/14

(52) U.S. Cl. CPC G01S 7/356; G01S 13/931; G06F 17/142

(57) ABSTRACT

A radar system is provided in accordance with various embodiments herein. The radar system includes a transceiver, an analog to digital converter (ADC), a digital processing unit coupled to the ADC, a control unit coupled to the digital processing unit, and a twiddle factor table. The digital processing unit includes a plurality of fast Fourier transform (FFT) elements and a plurality of memory storage devices coupled to the plurality of FFT elements. The plurality of FFT elements and the plurality of memory storage devices are configured in a pipeline. The control unit is configured to control each of the plurality of FFT elements a predetermined number of times. Each twiddle factor in the twiddle factor table corresponds to an FFT element in the plurality of FFT elements. A pipelined Fast Fourier Transform (FFT) sequence of radix-4 elements is configured in stages and can be operated iteratively.

### CROSS-REFERENCE TO RELATED APPLICATIONS

This application claims priority from U.S. Provisional Application No. 63/060,538, filed on Aug. 3, 2020, which is incorporated by reference in its entirety.

### BACKGROUND

Autonomous driving is quickly moving from the realm of science fiction to becoming an achievable reality. Already in the market are Advanced-Driver Assistance Systems (“ADAS”) that automate, adapt and enhance vehicles for safety and better driving. The next step will be vehicles that increasingly assume control of driving functions, such as steering, accelerating, braking and monitoring the surrounding environment and driving conditions to respond to events, such as changing lanes or speed when needed to avoid traffic, crossing pedestrians, animals, and so on. In such autonomous driving systems being developed, a radar is often used to detect one or more of the objects and determine the velocity of the objects. This and other information can then be used to project a path for the vehicle that avoids the object.

The requirements for object and image detection are critical and specify the time required to capture data, process it and turn it into action. In fact, such tasks are to be performed while ensuring accuracy, consistency and cost optimization. Moreover, extraction or determination of location, velocity, acceleration and other characteristics of detected objects is to be performed near-instantaneously; otherwise the detection may not be used to accurately control a vehicle at driving speeds over a variety of conditions. Therefore, there is a need for a system that can be used for real-time decision-making and to aid in autonomous driving.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates examples of FFT algorithmic computational configurations, in accordance with various embodiments of the subject technology;

FIG. 2 illustrates an FFT system for implementing FFT algorithmic computations, in accordance with various embodiments of the subject technology;

FIG. 3 illustrates a stage of an FFT architecture with single reused radix-4 element, in accordance with various embodiments of the subject technology;

FIG. 4 illustrates an FFT core architecture, in accordance with various embodiments of the subject technology;

FIGS. 5 and 6 illustrate memory allocations in stages of an FFT process, in accordance with various embodiments of the subject technology;

FIGS. 7-16 illustrate stages of a data pipeline in an FFT process, in accordance with various embodiments of the subject technology;

FIGS. 17-31 illustrate code for implementing an FFT process, in accordance with various embodiments of the subject technology;

FIGS. 32-35 illustrate twiddle tables for an FFT process, in accordance with various embodiments of the subject technology;

FIG. 36 illustrates a radar system incorporating an FFT element, in accordance with various embodiments of the subject technology; and

FIG. 37 illustrates a flowchart for an example method of using an FFT process, in accordance with one or more implementations of the subject technology.

### DETAILED DESCRIPTION

The present disclosure relates to methods, systems, and apparatuses for fast object detection and understanding that allows for real-time decision-making. The present disclosure provides examples of radar systems employing one or more components to enable fast object detection and real-time decision-making. In accordance with various embodiments described herein, a radar system can include, for example, among many others, a transceiver, an analog to digital converter (ADC), a digital processing unit coupled to the ADC, a control unit coupled to the digital processing unit, and/or a twiddle factor table. In various embodiments, the digital processing unit can include a plurality of fast Fourier transform (FFT) elements and a plurality of memory storage devices coupled to the plurality of FFT elements. The plurality of FFT elements and the plurality of memory storage devices can be configured in a pipeline. In various implementations, the control unit can be configured to control each of the plurality of FFT elements a predetermined number of times. In various embodiments, each twiddle factor in the twiddle factor table can correspond to an FFT element in the plurality of FFT elements.

The present application provides examples of radar systems employing frequency modulated signals. These signals interact with targets, or objects in the area covered by the radar unit and return to the radar unit with a time delay compared to the transmitted signal. The target parameters, such as range, may be measured by a change in frequency at the receiver, where this change in frequency is referred to as a beat frequency.

In frequency modulated continuous wave (FMCW) radar, the transmit signal is generated by frequency modulating a continuous wave signal. In one sweep of the radar operation, the frequency of the transmit signal varies linearly with time. This kind of signal is also known as the chirp signal. The transmit signal sweeps a frequency, f, in one chirp duration. Due to the propagation delay, the received signal reflected from a target has a frequency difference, called the beat frequency, compared to the transmit signal. The range of the target is proportional to the beat frequency. Thus, by measuring the beat frequency, the target range is obtained.

In FMCW radar, the target range is measured from the beat frequency, which is determined using a FFT process to identify the beat frequency. The FFT process provides a low computational complexity for the multiple operations required for analysis. The FFT process has frequency bins/grid of different frequencies, where N represents the set of frequencies. When a beat frequency of the target falls between the FFT grids in the middle of frequency bins, the detection performance is degraded. The degradation results from attenuation of signals, such as the amplitude of the reflected target signal, and reduces the resultant signal-to-noise ratio (SNR) and detection probability. To reduce the number of operations in an FFT process, twiddle factors are used to further reduce the computational complexity. In processing digital sample sets, the digital Fourier Transform (DFT) is a linear transform of a time domain set of signals (or samples) to a set of coefficients of component sinusoids of time domain signal describing the signals.

In an automotive system, the FFT process can be applied to the received signals, which are converted from an analog received signal to a digital signal. The digital signal creates the sample inputs to the FFT process, enabling extraction of radar parameters, as the return time of a radar signal directly indicates the distance or the range to the object. Velocity, as well as other measures and information about the detected object, can be calculated by the phase shift in a return signal, requiring time to frequency domain conversion. To accomplish conversion with sufficient time to react, one or more FFT processes can be implemented.

The automotive application is similar to other applications, in that there are significant amounts of data to be processed within a time limit. There are a variety of methods or configurations to build such a system in a hardware to implement a FFT process. The present disclosure considers a non-limiting embodiment that includes a sample size of 256 points and uses a radix-4 FFT core with a reduced hardware structure. The FFT process includes 4 stages of operation, for example, wherein each stage has 16 FFT elements. Each stage is coupled to a storage device, memory, buffer or register to store interim results. Each stage processes a portion of the data. Each FFT element cycles or steps through the process 4 times. In other words, each FFT element is run 4 times. As each stage completes processing, the output is provided to the next set stage of 16 FFT elements. The data continues to move through the stages in a pipelined manner, wherein the next (second) portion of data may enter the first stage after the first portion of data moves to the second stage (i.e., stage 2). This process is controlled by a processing unit that ensures the integrity of the pipeline. In various embodiments, the pipeline may be configured to fully process a first set of data (256 points). In various embodiments, the first portion of a next set of data enters stage 1 after all of the first data has been processed in stage 1. In such implementations, a controller can be used to indicate when a data set is able to start processing. This controller may be a general-purpose controller, an application specific controller, or may be controlled by other portions of the application. In an automotive application, this controller may be part of a radar unit, a sensor fusion controller, or another controller.

In data sample processing, discrete Fourier transform (DFT) methods can be used to identify a frequency spectrum, specific frequencies making up the waveform, or series of data points. In various embodiments, the FFT process may be used to reduce the time required to complete a frequency conversion, as discussed in the present disclosure. In various embodiments, the FFT process may be implemented to quickly identify the frequencies composing a sampled signal.

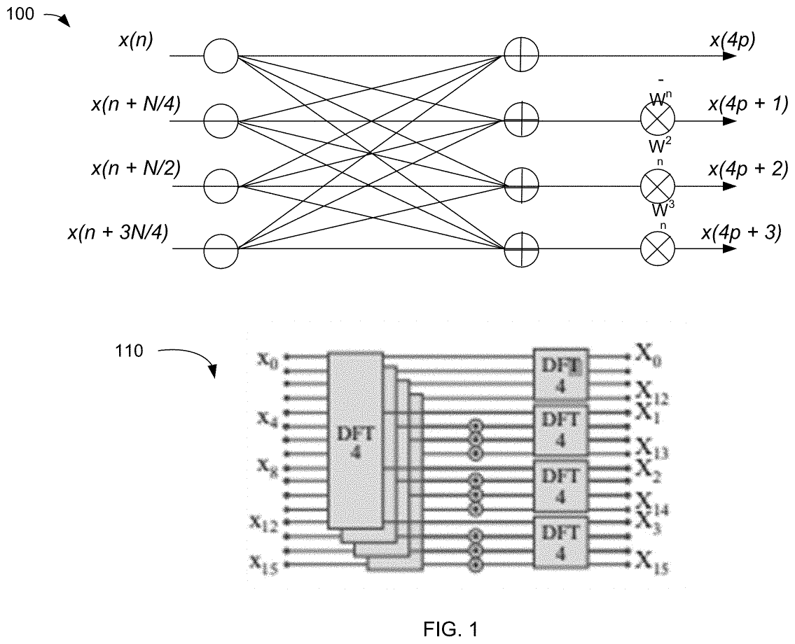

FIG. 1 illustrates examples of FFT algorithmic computational configurations, in accordance with various embodiments of the subject technology. The various FFT algorithmic computational configurations illustrated in FIG. 1 include FFT models, including for example, but not limited to, a radix-4 FFT 100 having four inputs (left-hand side) and four outputs (right-hand side) with various connections for processing data. The radix-4 algorithm is described as a butterfly shape having four inputs and four outputs. The FFT length is defined by the number of Stages. In the Discrete Fourier Transform (DFT) 110, sixteen inputs are input in sets of four, and are output in sets of four. To reduce the complexity and speed up processing of the FFT and DFT operations, twiddle factors, which are represented by W, are a set of values applied during processing. The twiddle factor effectively adds a rotating vector quantity and periodicity to the complex multiplications and additions during processing.

The present disclosure relates to methods and apparatuses improving speed of calculations and processing in computational systems employing FFT algorithms. In accordance with various implementations, the FFT clock cycles are a limiting factor in increasing the speed of processing. Further, the latency of the FFT process can be reduced using an algorithmic computational structure having fewer stages, which in turn reduces complexity of the circuitry and reduces the size of the FFT element. The various examples disclosed herein are described using a pipelined FFT processer of radix-4. While current solutions avoid the radix-4 solutions as complex and costly, the present disclosure is directed to methods to utilize the strength of such solutions while reducing complexity, hardware and cost. A twiddle table is built to list the values applied to data during the FFT processing. The twiddle factors in the twiddle table is designed to avoid overlap of Stages in the FFT process. As used herein, the term table refers to the twiddle table, and in this example the table is a look up table (LUT) and these terms may be used interchangeably; however, alternate embodiments, memories and constructs may be used for generating, storing, accessing and/or applying the twiddle factor(s).

The following illustrations and descriptions present examples in detail and provide an overview of the implementations for a pipelined FFT with localized twiddle factors for use in processing data in real time environments, such as for radar object detection and identification. The FFT provides flexibility in applications involving 4, 16, 64, 256, 1024, 4096, . . . point FFTs. This concept may be extended as desired for a variety of applications. The twiddle factor is a trigonometric constant used as a coefficient multiplied by data in the course of the algorithm.

FFT algorithms may be used for various applications for sampling time samples and computing frequency domain samples. The twiddle factors are values applied to the data in the FFT algorithm. In some example embodiments and implementations, the twiddle factors are trigonometric constant coefficients multiplied by the data used in the algorithm, wherein the radix-4 FFT gains speed by reusing results of smaller, intermediate computations to compute multiple discrete Fourier transform (DFT) outputs. The reuse of the results provides efficient computations, wherein each of group of four frequency samples constitutes the radix-4 butterfly. The radix-4 decimation in time algorithm rearranges the DFT equation into 4 parts and sums over all groups of every fourth discrete-time index. In the DFT definition and algorithm, X(k) of an N-point sequence x(n) is defined by

$$X ( k ) = {\sum }_{n = 0}^{N - 1} x ( n ) {W}_{N}^{n k} k = 0 , 1 , … , N - 1 ; and$$

$${W}_{N}^{n k} = cos ( \frac{2 π° nk}{N} ) - j sin ( \frac{2 π° nk}{N} ) = {e}^{- j \frac{2 π * n k}{N}}$$

wherein the W_{N}ⁿ is referred to as a twiddle factor. Selecting an FFT radix is a first step on the algorithmic level. It is mainly a trade-off between the speed, power, and area for the number of transistors. High-radix FFT algorithms, such as radix-8, often increase the control complexity and are not easy to implement. The examples described herein can be implemented with a radix-4 design to reduce the complexity and to provide a comprehensive view of these structures and processes.

In various FFT architectures and methods, a specific design corresponds to a specific FFT, such as a 256-point FFT or 64 point FFT, where the FFTs are not interchangeable. The present disclosure presents a flexible FFT architecture and process incorporating a radix-4 element. It is a very fast and efficient way to implement an FFT process in such a way as to be used in various dimension FFTs. In the present examples, the radix-4 element is used to create higher order FFTs in software, hardware, and/or both. The process can be used to generate the twiddle factors and stores these in a lookup table (LUT) or other storage location coordinated with the algorithm and 4-radix structure of calculations. The FFT algorithm calculates the indexing of the LUT, such that larger LUTs are used for smaller FFT sizes, such as where a larger LUT may have 256 sample points. This makes the design flexible to accommodate many types of input data in a variety of applications.

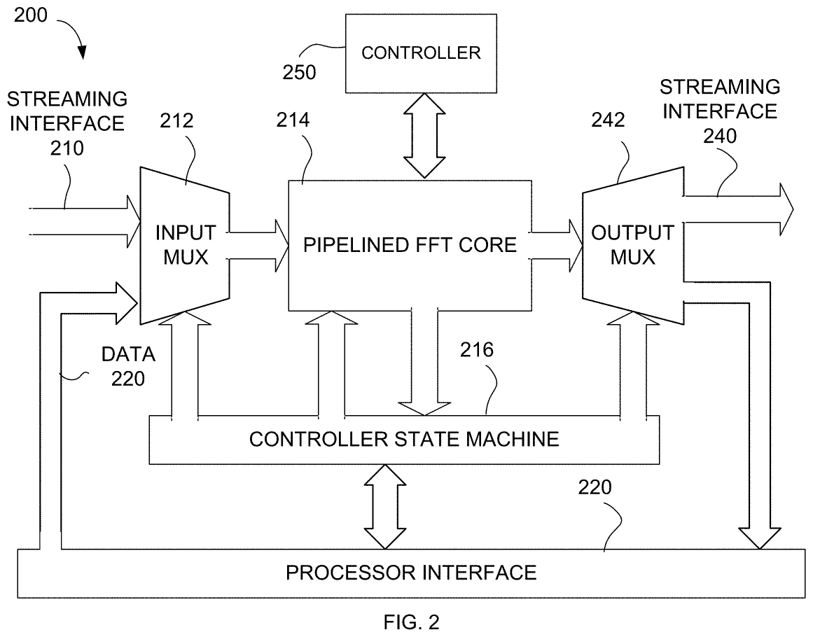

Now referring to FIG. 2, which illustrates an FFT system 200 for implementing FFT algorithmic computations, in accordance with various embodiments of the subject technology. The FFT system 200 is a pipelined FFT algorithm that can be implemented in hardware illustrated in FIG. 2 and is based around a pipelined FFT core 214 (“core 214”), which operates to perform FFT, or DFT, operations on samples of received data. The core 214 may be implemented in software, firmware, hardware, application-specific integrated circuit (ASIC), or other construct to meet application specifications and requirements as well as to further facilitate reduction in the calculation time for these processes. Coupled to the core 214 are input multiplexer or MUX 212 and output multiplexer or MUX 242. Inputs to the input MUX 212 may include data, or digital samples, from a processor interface 220 and/or streaming information via streaming interface 210 (generally referred to herein as “processor interface 220”). The processor interface 220 may be coupled to other portions of a system, such as a radar system, a sensor fusion element or sensor fusion controller in an automotive system. In the present examples, the processor interface 220 is configured to communicate with a central processor (not shown) for the application/system and enables the implementation of the FFT processing in a variety of scenarios.

The present examples are automotive object detection applications; other applications may include, but not limited to, sampling of large sets of data. The processor interface 220 is configured to share data and/or instructions with a controller state machine 216 that also interfaces with input MUX 212, output MUX 242, and the FFT core 214. The input MUX 212 outputs data to the core 214 to flow through the stages of data processing which are implemented in the pipelined process of the core 214. The controller state machine 216 is configured to control, communicate and coordinate with core 214, input MUX 212 and output MUX 242. The output MUX 242 distributes data to streaming interface 240 and/or to the processor interface 220. The system 200, including the pipelined FFT core 214, implements the desired processes to detect objects within a field of view of the radar element; this may be performed according to an algorithm, set of instructions or circuit configuration. Additional components (not shown) may be used to couple the system 200 to other parts of an application system or element. The system 200 generates preliminary control information, where data is passed through to and from each processing step.

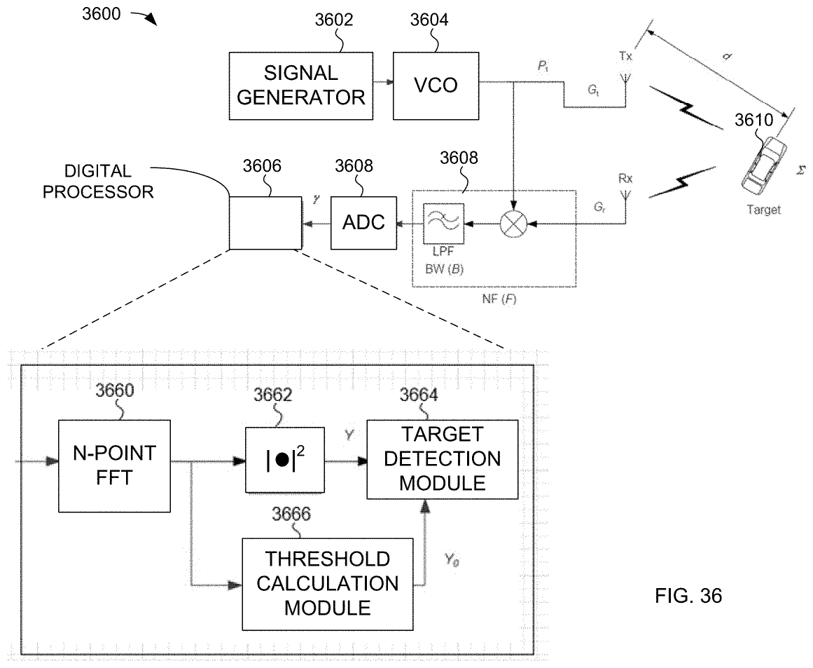

The present disclosure includes a method for using a smaller point FFT element to perform iteratively and behave as an FFT of a higher point count. When implemented in hardware, such as a specialized circuit, a large sample set of FFT elements may be processed with reduced hardware. In the examples presented herein, a core FFT architecture builds on a radix-4 FFT element, performing calculations as in FFT 100 of FIG. 1. Multiple radix-4 FFT elements are organized into stages; in the examples herein, each stage may include 16 FFT elements. At each stage, the FFT elements process data and output to a next stage through an interim buffer or register. The stages are pipelined and enable data sets to be effectively processed in parallel. In an automotive radar application, the data sets represent electromagnetic signals (e.g., radar signals) received in the environment. Some of these signals are reflections from targets or objects in the environment, such as in a field of view of a radar unit. A radar unit, such as for example, radar system 3600 shown and described with respect to FIG. 36 may be positioned on a vehicle and transmits radar signals into the path of the vehicle. The radar system 3600 has a defined field of view within which objects are detected. For operation at vehicle speeds, it is critical to process received signals quickly in real time. The transmit antenna sends a modulated signal which is reflected off objects such as car 3610. The return signal is processed through a transceiver and converted into digital signals. The digital processing then removes noise and identifies targets, extracting information to generate range Doppler mappings (RDM). The system 200 can be used as FFT 3660 illustrated in FIG. 36. Further details are provided below, with a focus on response time required for processing, which is a limiting factor in performance of a given radar system.

In a digital signal processing (DSP), the Fast Fourier Transform (FFT) is a fundamental building block which may be implemented in software or in hardware, such as digital logic, application-specific integrated circuits, field programmable gate arrays, and so forth, and is used for rapid real time processing but is not without complexity. The FFT is time-limited by cycles to execute instructions, such as and especially when they are organized serially. The hardware FFT is able to perform steps in parallel to improve throughput as compared to software-implemented FFTs. Each FFT is configured according to an algorithm or processing recipe. The FFT processing involves fetching data, multiplications, additions and/or storing data, among many others. One design is a butterfly operator, which is illustrated as FFT 100 in FIG. 1.

The present disclosure is described with respect to a radar system, however may be applied to other systems. As disclosed above, FFT 100 illustrated in FIG. 1 has four inputs, four outputs and connections therebetween. The present disclosure is an implementation of a radix-4 based FFT with flexibility for calculations in a variety of applications. The examples presented herein can be modeled in Verilog and Matlab, and can be designed to provide sufficient flexibility to work as 4, 16, 64, 256, 1024 and other point valued FFT architectures. Multiple radix-4 elements are configured to use in a pipelined fashion. The radix-4 elements are used herein as they are fast and efficient performing as the 4-point FFTs. Further, FFT architectures and processes disclosed herein use a radix-4 element to create higher order FFTs which may be used in a variety of architectures. The FFT models presented herein can be implemented to be iterative. They support FFTs having sizes 4, 16, 64, 256, and so on. The iterative algorithm and the data storage requirements are well suited for hardware implementation.

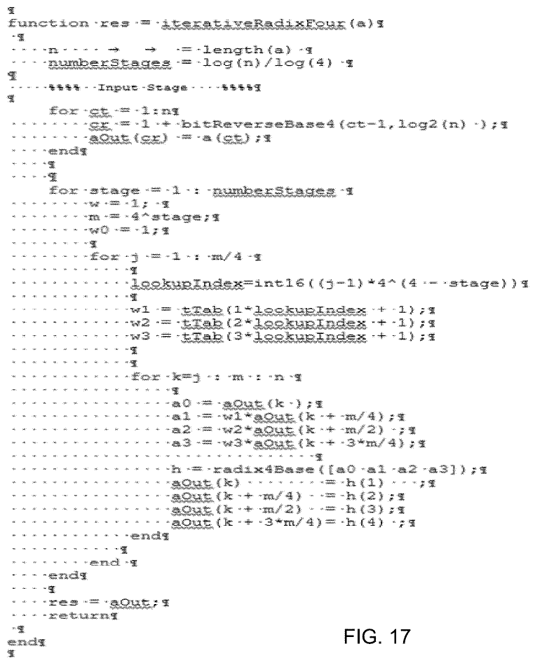

An example of an FFT process created in Matlab is illustrated in FIG. 17. The code provides the details for an iterative FFT implementation using a radix-4 element. The use of radix-4 enables other sized FFTs using an iterative process or algorithm. Results of the FFT processes may be stored in a set memory location, in accordance with various implementations. The FFT processing set up includes generation of twiddle factors, which are stored in memory, such as a look up table (LUT), and calculates indices for the LUT to map twiddle factors to radix-4 elements in the FFT architecture. According to this FFT algorithm, a 256-point LUT may be used for smaller FFT sizes as well. In an example of a 256 FFT, a table of 256 twiddle factors may be implemented; wherein the same table may be used for smaller FFTs as subsets of the 256 points, such as for 64 points, without regeneration of the table based on a smaller FFT size that is a subset of the 256 FFT. The present disclosure avoids the need to regenerate tables, as it may be used for smaller size FFTs as desired.

The core 214 is incorporated into an element controllable through a controller 250, which may be an ARM processor or any suitable computer processor. An ARM processor is one of a family of central processing units (CPUs) based on the RISC (reduced instruction set computer) architecture developed by Advanced RISC Machines (ARM). The controller 250 may overwrite or directly write into the input MUX 212 and read from the output MUX 242. The control information is generated in the controller 250; otherwise the data is passed through to the next processing element directly as desired through a streaming interface 240.

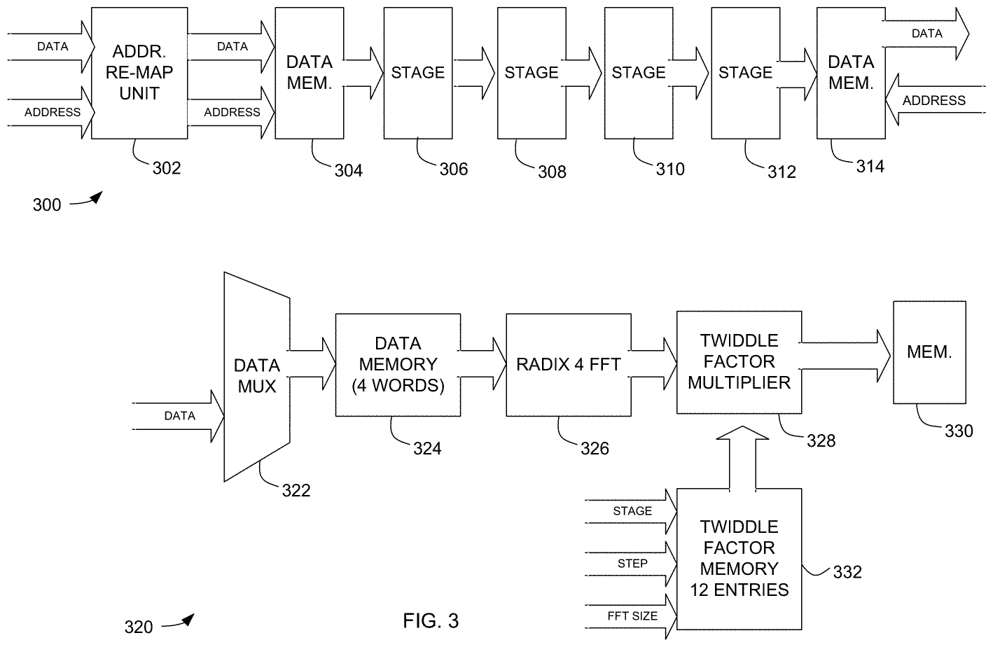

FIG. 3 illustrates a stage of an FFT architecture with single reused radix-4 element, in accordance with various embodiments of the subject technology. FIG. 3 provides data flow details of a pipeline FFT core, similar to core 214 of FIG. 2, which is also referred to as an FFT core engine or FFT architecture or FFT core architecture. The radix 4-FFT receives four inputs; it then generates the correct outputs incorporating the correct twiddle factors. The present example incorporates 16 of the radix-4 elements in each stage of the pipeline, and each radix-4 element runs four times. When processing of a given stage is completed, the output of that stage is the input of a next stage, according to the pipelined nature of the FFT architecture. The following discussion considers a 256-point FFT with architecture optimized accordingly.

In various embodiments, an FFT may be defined by the number of stages. Each stage performs multiple radix-4 operations. To process data samples of 256 points, the FFT design has 4 stages with each stage processing all 256 inputs, where inputs for stages following stage 0 are each provided from the outputs of a prior stage. Specifically, each stage has 4 inputs and 64 radix-4 operation. Technically, these 64 radix-4 operations can run in parallel, however, such an architecture would require excess hardware. The present disclosure overcomes this complexity and breaks this down further and provides 16 radix-4 elements which run in parallel; in this case, each stage takes 4 cycles to complete. In the present examples, there are 256 data points as inputs per sample. To process these 256 inputs, there are 64 radix-4 operations per stage. The breakdown is 4×64 inputs, 16 radix-4 operations performed 4 times to process the 256 inputs; in this way, each of the 4 stages includes 4 cycles. In this way, the process has 4 stages. Each stage has 16 radix-4 elements. Each stage processes 4 times, which may be referred to as steps or cycles. Accordingly, with 4 stages, each having 4 cycles, the FFT processes the 256 points in 16 cycles.

The methods, processes and architectures provided herein present a fully pipelined system, which allows an FFT to run in four cycles, where the latency is 16 clock cycles. The architecture makes this FFT an efficient solution for use in radar applications, with vehicular radar systems in particular.

Each stage performs 64 of the radix-4 operations made up of multiple calculations. Each stage manages its own dataflow. Since the number of radix-4 elements is reduced to 16, each stage performs its task in 4 cycles which leads to a latency of 16 cycles, where the latency is the time for data samples to go through the FFT. In the pipelined architecture, it is possible for a new sample set or 256 points to begin processing every four cycles. This process resolves the issues associated with other methods since it uses a reduced set of 16 of the radix-4 elements at each stage and a corresponding reduced set of registers, which in this case is 16 registers. As used herein, register, memory, buffer, database or other data storage device may be implemented interchangeably as appropriate.

The calculation of the number of stages is a function of the number of inputs, and in the present examples is determined by the logarithm of the number of inputs N. In a radix-4 case, the logarithm of base 4 is used and therefore, log 4(256)=4 and thus the design implements 4 stages.

The input data to the FFT pipeline is reorganized for processing in the radix-4 elements. In accordance with various embodiments disclosed herein, inputs, N, to the FFT is the set of 2, 4, 6, 8, and may extend to 10 or any other suitable number. When a single element is used, then the lowest bits are considered, and upper bits are ignored when selected. For remapping of different FFT sizes, flipping digits or bits is based on the size of the FFT addresses (0-255), each represented by 8 bits. A digit reversal method is used to remap or reorder the input addresses. The inputs to the FFT pipeline are reordered in address re-mapping unit 302 of FIG. 3 where addresses are inversed by digits of base 4. The input parameters to unit 302 include at least the number of stages of the FFT and the address of the data. The number of stages is calculated as base-4 logarithm of the number of points. In this example, the number of points is 256, and the base-4 logarithm of 256 is equal to 4. The input bits, N, are the set of 2, 4, 6, 8, and may extend to 10 or any other suitable number. When a single element is used, then the lowest bits are considered, and upper bits are ignored when not selected. The flipping of bits or digits is adapted according to the size of the FFT.

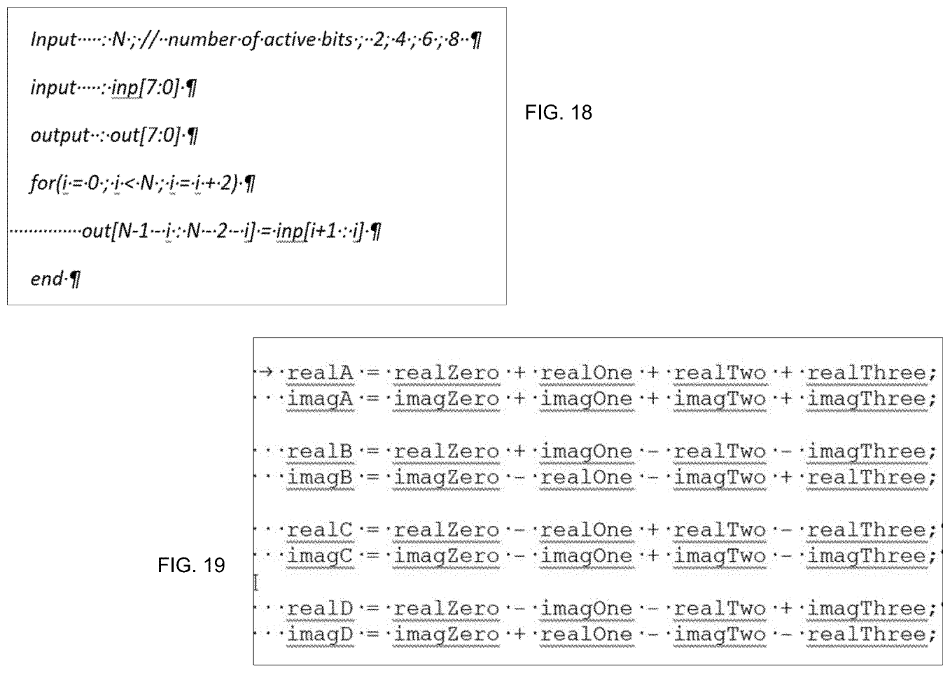

As an example, FIG. 18 illustrates an example of a remapping algorithm that switches pairs of bits based on the maximum number of applicable address bits. Even if the maximum number of bits can be increased, a lower number of points can be implemented with the same process or hardware. Using a 256-point FFT, 64 of 256 registers are accessed in parallel wherein the 256 memory locations are implemented as a register array.

Referring back to FIG. 3, the pipelined FFT architecture 300 inputs data and address information to an address remapping unit 302, where remapped data and addresses are provided to data memory 304. The process continues through one or more of multiple stages 306, 308, 310, and/or 312 to data memory 314 and output data. The stages 306, 308 and 310 are pipelined stages. Address information is input into data memory 314. In this processing, the pipelined radix-4 FFT core takes four inputs and generates the outputs incorporating the calculated twiddle factors. The current example has 16 radix-4 elements in each stage of the FFT (306, 308, 310, 312), wherein each stage runs four times. An example of the addition and subtraction phase of the pipelined FFT architecture 300 are illustrated in FIG. 19, where the real and imaginary parts are 4 complex inputs.

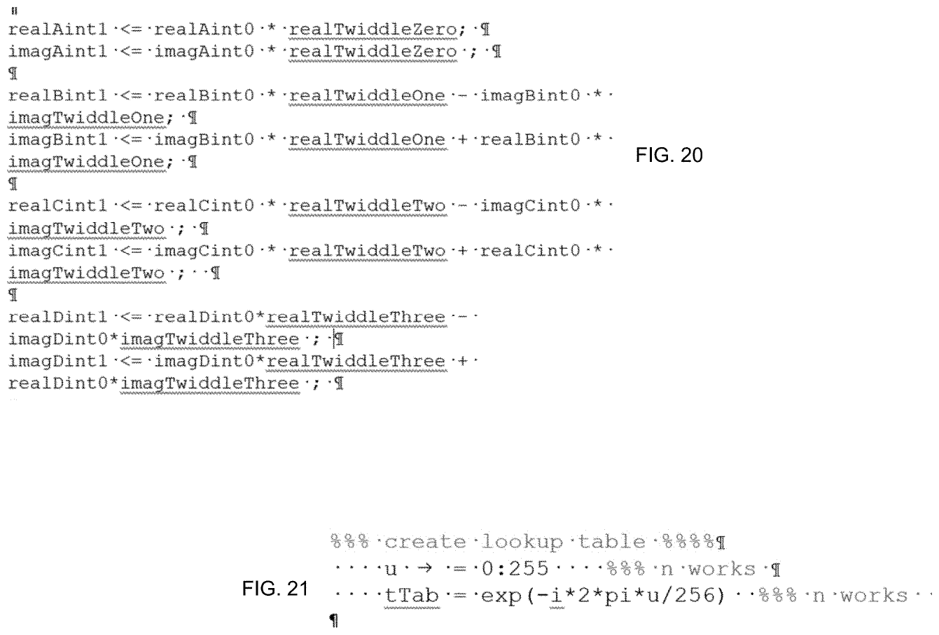

The radix-4 element has an associated fixed twiddle factor, which is modeled simply by multiplication with real or imaginary ones. Therefore, the results are already correct (e.g. 1) as stated above and no additional multiplication with a twiddle factor is implemented. For a higher order FFT the multiplication of the twiddle factor happens outside of the radix-4 element. The next phase is the multiplication phase which multiplies the twiddle factors. For the radix-4 FFT, the twiddle factors may be externally generated. FIG. 20 illustrates an example Matlab code where the first twiddle factor remains the same and equal to 1.0, and is referred to as twiddleZero in example code, and the line is omitted. When the twiddle factor is 1.0, there is no need to perform the actual multiplication by the twiddle factor but rather the value passes through to the next stage or process; such a twiddle factor does not require a multiplication operation and may be omitted from the table. The radix-4 element itself implements a 4-point FFT. When combined in a higher order FFT, the inputs are organized using twiddle factor tables.

The FFT computation is performed through multiple stages. With a radix-4 based system, the number of stages is calculated as the logarithm of the number of inputs at base four. The first step in the process is to select the correct inputs, perform the radix-4 operation and then multiply the four outputs with the appropriate twiddle factor. The twiddle factor depends on the total number of stages, the current stage and the index. If one 4-point FFT is calculated, there is no twiddle factor necessary, or that the twiddle factor points naturally to the value 1.0; in this case the multiplication may be omitted. For each stage of the FFT, a subset of the twiddle factors can be used. The twiddle factors are generated locally for each stage and organized in a meaningful manner according to the implementation and design. The organization of the twiddle factors is therefore revisited for each stage.

An example illustrated in Matlab code is provided in FIG. 21, where the system generates 256 twiddle factors, however, the actual number is smaller for each stage. During a twiddle factor lookup stage, the inputs to the twiddle factor memory 332 include the stage number, the number of total points or FFT size, and the current index or step. The present disclosure provides a novel FFT lookup process using and maintaining a single table to provide twiddle factors for various sizes of FFTs. In the examples presented herein, a radix-4 based FFT may be used for sizes 4,16,64 and 256, wherein 256 is the maximum size. In the following calculation the stage number is given as 0,1,2,3 resembling a 4, 16, 64 and 256-point FFT. The process calculates a lookup index as:

lookupIndex=((j−1)*4^{(4-stage)})
with j=l:m/4
w₀=tTab(0*lookupIndex).

In this example, tTab represents the twiddle table, and the input j is the other input to the equation aA=πr²nd 4 lookup indices are calculated. The four twiddle factors are formed in the twiddle Table (tTab) are looked up as follows:
w₀=tTab(0*lookupIndex);
w₁=tTab(1*lookupIndex);
w₂=tTab(2*lookupIndex); and
w₃=tTab(3*lookupIndex).
   In this example, u represents the twiddle table. The first twiddle factor points to the entry u(0), which in this case is equal to 1.0, and the calculation of this twiddle factor may be omitted, saving a multiplication. When generated in hardware, a memory includes multiple read ports to enable multiple radix 4 elements to perform operations in parallel.

When the lookup index is directly considered as the input address to the lookup table, then 4 results may be read simultaneously from the table with more data bits in parallel. There are 4 related results (0*lookupIndex, 1*lookupIndex, 2*lookupIndex and 3*lookupIndex): the lookupIndex is between 0 and 63 for a 256 FFT, as every lookup produces 4 results. It is thus possible to prepare the table in such a way that those 4 twiddle factors are concatenated into one longer word and a single access to the lookup table would provide the 4 relevant results.

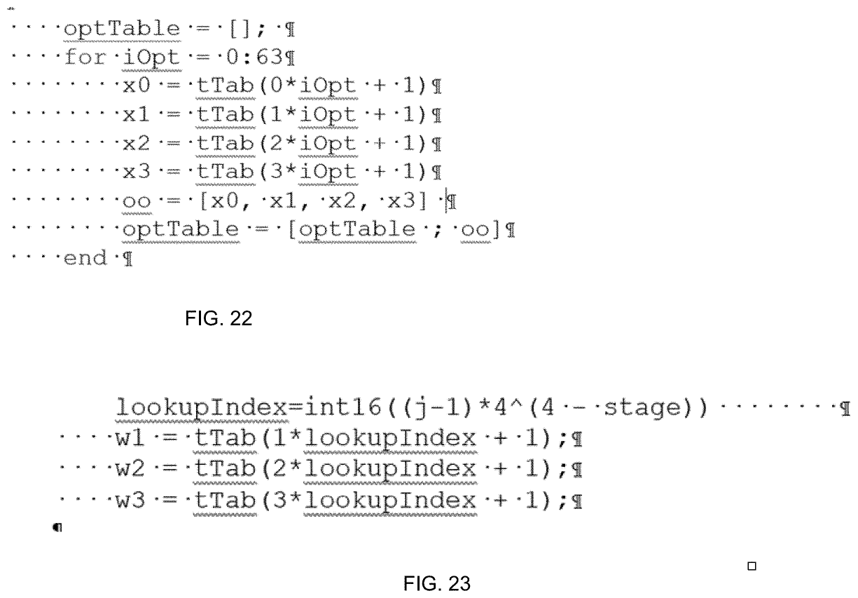

FIG. 22 illustrates example Matlab code to prepare a LUT according to the method described above. The code generates the 64 entries in the LUT from the existing LUT prepared before, where the 0 element is included in the example for mathematical completeness but may be omitted for a practical implementation. As it is possible to omit the 0 index operations, a hardware requirement may be reduced to 75% of the memory of other solutions. As such, there are 64 entries with 3 relevant values whereas the original table carries all 256 values. Other optimizations allow further reduction to the number of entries. In designing these FFT circuits, it is important to consider multiple parallel accesses to the LUT, as these may restrict further optimization in circuit design. Continuing with operation, the process uses the lookupIndex as an address; a single word containing 4 twiddle factors may be returned in parallel. For example, with I and Q components and 16-bit resolution, each single word may be 3*2*16 or 96 bits. Parallel radix-4 elements may be used as several elements may share twiddle factor(s), and in the examples presented herein parallel processing is possible for 3 of the 4 stages.

The following table illustrates the number of memory reads in one approach and in an optimized approach at the different stages of the FFT.

TABLE 1
Memory Access using an updated twiddle factor scheme

Memory Access Count

| | Traditional Approach | Optimized Table Approach |
|---|---|---|
| Stage 0 | 4 | 1 |
| Stage 1 | 16 | 4 |
| Stage 2 | 64 | 16 |
| Stage 3 | 256 | 64 |
| Total | 340 | 85 |

The number of memory accesses may be a critical parameter to determine the performance and throughput of a given system. The other portion is the number of radix-4 elements. In this model, the radix-4 performs the operation in a single step. Based on this example the maximum number of radix-4 elements to run in parallel would be 64, which would be fully utilized in a first stage, labeled herein as stage 0. In the next stage, stage 1, 16 elements would run in parallel; in stage 2 there are 4 elements running in parallel and finally in the final stage, stage 3, there is 1 element running in parallel. To optimize timing with a fully parallelized system, based on the stated memory accesses of Table 1, each stage performs 64 radix-4 calculations.

TABLE 2
Timing of Radix-4 FFT with improved
twiddle factor table approach

Best Total Time with Parallel Radix-4 elements

| | Number of Radix- | Traditional | Optimized |
|---|---|---|---|
| Stage | 4 elements | Approach | Table Approach |
| 0 | 64 | 5 | 2 |
| 1 | 16 | 20 | 8 |
| 2 | 4 | 80 | 32 |
| 3 | 1 | 320 | 128 |
| Total | 85 | 425 | 170 |

As shown in Table 2, the disclosed approach significantly reduces the timing. The physical hardware and footprint may also be reduced as the address decoder for addressing the table. As 4 twiddle factors are combined into one table entry, the address decoder for that table is reduced to 64 entries rather than 256 as the total table size, or number of entries in the table, is reduced; however, each entry itself is 4 times larger. Address in these examples is greatly simplified. Alternate examples may use 16 radix-4 elements in stage 0 and still perform the calculations in 5 steps compared to a traditional approach which would take 8 steps. To add more radix-4 elements in the last stage may not improve the process as memory access is limited at this point. A similar limitation exists for the main memory which holds the data. Assuming the FFT has a total of 16 radix-4 elements, then the output of a stage is fed back as the input to the next stage.

The present examples localize the twiddle factors. When twiddle factors are combined for each radix-4 element, such as 4 twiddle factors as described hereinabove, 1 is used for each radix-4 element and if the same radix-4 element is reused through multiple stages then each radix-4 operation is associated with the relevant twiddle factors. Each stage has its own twiddle factor table, which contains the twiddle factors relevant for that stage. As each stage basically has the information to proceed, the table is localized as compared to a shared table where access to the table must be coordinated resulting in delays. The present disclosure solves the problems of these prior solutions and reduce processing time by the introduction of a local individual twiddle factor table for each stage. The present disclosure includes tables that are approximately the same size as, or less than, a general-purpose table.

Now referring to FFT architecture/process 320 in FIG. 3, which illustrates a radix-4 element with the twiddle factor. Each element has a different set of twiddle factors. As in the other examples presented herein, the inputs to twiddle factor memory 332 include the current stage, and FFT-size and which step is taken—one of the 16 radix-4 elements available. The 16 FFT elements are in the FFT architecture/process 320 incorporating a six-bit control word to select the appropriate twiddle factor for a specific step. The content of the twiddle factor memory 332 is calculated based on the index of the specific radix-4 element. In different variations or configurations, the twiddle factor data memories may take various forms, which may introduce overhead in an implementation, such as if a single element is reused.

To resolve the limitations on the twiddle factor, the present disclosure employs a different approach each stage. Some examples present the in-place twiddle factor generation, where each stage has its own well-defined twiddle factor LUT. Since not all twiddle factors are used for each stage, it is expected that the total size of the LUT will not exceed the size of a shared table.

The present disclosure describes how to relax the twiddle factor bottleneck. Table 3 illustrates the timing of different solutions.

TABLE 3
Timing of Radix-4 FFT with parallel Radix-4 elements

| | Total Time with Parallel Radix-4 elements | | |
|---|---|---|---|
| | Number of Radix- | Traditional | Optimized |
| | 4 elements | Approach | Table Approach |
| Stage 0 | 64 | 5 | 2 |
| Stage 1 | 16 | 20 | 8 |
| Stage 2 | 4 | 80 | 32 |
| Stage 3 | 1 | 320 | 128 |
| Total | 85 | 425 | 170 |

And the following table details the architectures presented herein with localized twiddle factor LUTs.

TABLE 4
New architecture with localized twiddle factor tables

| | Proposed Pipelined Architecture | | |
|---|---|---|---|
| | Number of Radix- | twiddle | |
| | 4 elements | Table Size | Latency |
| Stage 0 | 16 | 0 | 4 |
| Stage 1 | 16 | 10 | 4 |
| Stage 2 | 16 | 46 | 4 |
| Stage 3 | 16 | 190 | 4 |
| Total | 64 | 246 | 10 (pipelined!) |

The present example calculates a 25-point FFT in 10 clock cycles, or pipeline cycles, because once the first portion is calculated it moves into the next stage immediately; this continues for the first 3 stages. In this way, the next FFT may start in 4 cycles, the delay, as the radix-4 elements are reused 4 times. This provides a balance of element reuse and speed; when combined with radix-4 elements and the localized twiddle factor LUTs, these processes allow highly efficient FFTs for applications such as automotive radar and others.

The pipeline and data flow for the FFTs presented herein is made up of 4 stages and steps. In addition to that the control mechanism is localized, which means that the control system is very compact and efficient. The control information is passed on from one stage to the next to align it with the data.

Continuing with FIG. 3, the FFT architecture/process 320 includes data MUX 322 providing data memory. This is output to radix-4 FFT. The process continues to twiddle factor multiplier 328 and stored in memory 330. The twiddle factor memory 332 stores the twiddle factors and receives information for the stage, step and FFT size.

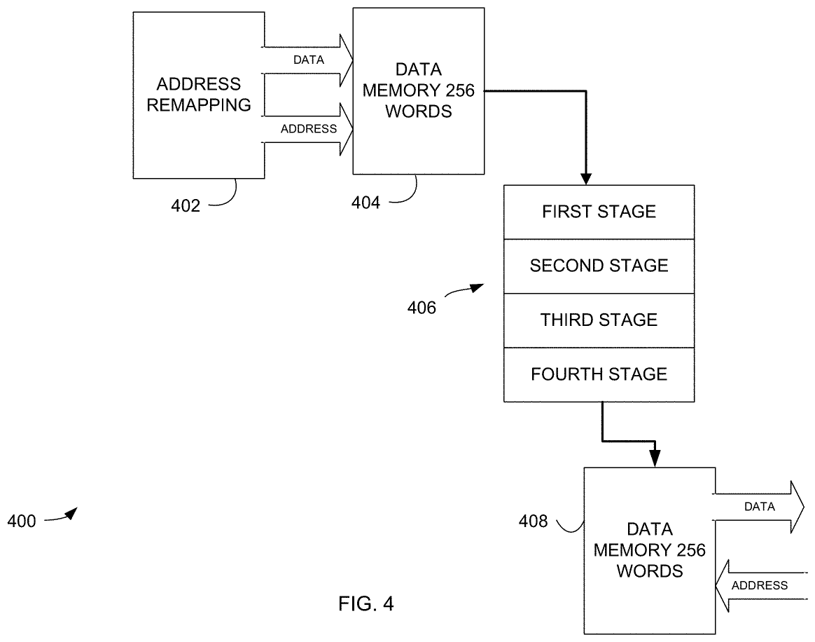

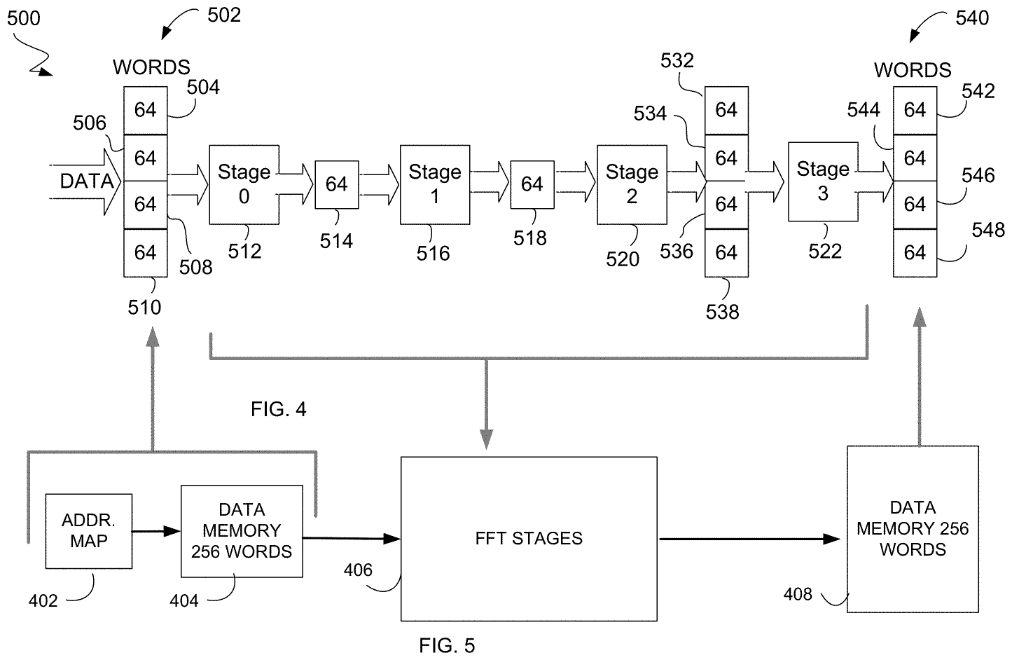

These examples consider a pipelined FFT architecture 400 (in FIG. 4 discussed below) for processing 256 data point sets. The FFT architecture is optimized for these conditions, wherein the pipelined FFT 400 is defined by the number of stages and each stage performs multiple radix-4-based processing steps. In the case of a 256-point FFT, four (4) stages are used, each performing sixty-four (64) radix-4 operations. A fully pipelined system, runs the FFT in four (4) cycles with a latency of approximately sixteen (16) clock cycles. The pipelined FFT architecture 300 creates a very efficient FFT for radar applications. Each stage performs sixty-four (64) radix-4 based calculations and manages its own dataflow. When the number of radix-4 elements is reduced to sixteen (16), each stage performs its task in four (4) cycles which leads to a total latency of sixteen (16) cycles. In this example, there are 64 radix-4 calculations done in each stage to calculate the 256 values. This may be done in parallel using 64 radix-4 elements in one cycle, or as presented herein, this may be done using 16 radix-4 elements, which operates on 64 values in parallel, and takes 4 cycles to run all 256 values. As in each stage there are 16 radix-4 elements are run in parallel and for 4 cycles, and there are 4 stages, that results in a total latency of 16.

In such a pipelined architecture, a new FFT calculation may be started every 4 cycles, wherein a new FFT calculation is a new set of 256 points of data. This concept is superior to other concepts since it uses sixteen (16) radix-4 elements at each stage and 64 registers in 3 of the 4 stages.

The elements of the FFT architecture/process 320 of FIG. 3 include radix-4 FFT element 326, input addressing and memory 324, twiddle generator and twiddle multiplier 328, twiddle factor memory 332 (or Tiddle LUT), and output memory 330. In the present examples, an input addressing and memory scheme organizes and reuses data. Before the data is fed into the FFT radix-4 element 326 it is reorganized in a specific manner. In the radix-4 based FFT, the input Stage provides the main challenge for prior attempts to improve the speed of FFT. Similar to a radix-2 Stage FFT, a bit-reverse method is applied to the index to reorder the inputs; this is a digit reverse step for the index. The radix-4 is a quaternary system and the index is represented in a quaternary number system, which is base four (4), so the reordering of the indices may be done with a digit reverse algorithm. It still may be performed using bit-manipulating instructions, since each digit is represented by two bits. The present disclosure provides an element that allows inputs to be reordered as they are written into the input memory. The addresses thereby are inversed by digits of base four (4). The input parameters are the number of stages, which is the base four (4) logarithm of the number of points. There are four stages for a 256-point FFT. The other input is the address itself. The following may be implemented for N input bits, with N being 2, 4, 6 or 8, and may extend to 10 or any other suitable number. If a single element is used, the lower bits are considered and upper bits are ignored if they are not selected.

FIG. 4 illustrates an FFT core architecture, in accordance with various embodiments of the subject technology. FIG. 4 illustrates such an FFT architecture 400 from address remapping unit 402, which outputs data and re-address information as input to data memory 404. Processing continues through the stages 406, which has 4 stages, and finally to data memory 408. As discussed, the code of FIG. 18 may be used to remap the address bits.

In the twiddle factor lookup stage, the input is the stage number, the number of total points and the current index. The twiddle factor is calculated based each case given by the following information: i) the stage, ii) the size of the FFT, and iii) the index of the input. The embodiments and implementations disclosed herein are superior to prior methods as the same twiddle factor table is used for different cases. The address calculation of an FFT may be adopted from a table generated for a different size FFT. In other cases, the twiddle factors are calculated based on a new FFT size. For this innovative FFT lookup process, a single table is maintained for use to provide twiddle factors for various different FFT sizes. The examples presented herein for radix-4 based FFT enables sizes are 4, 16, 64 and 256.

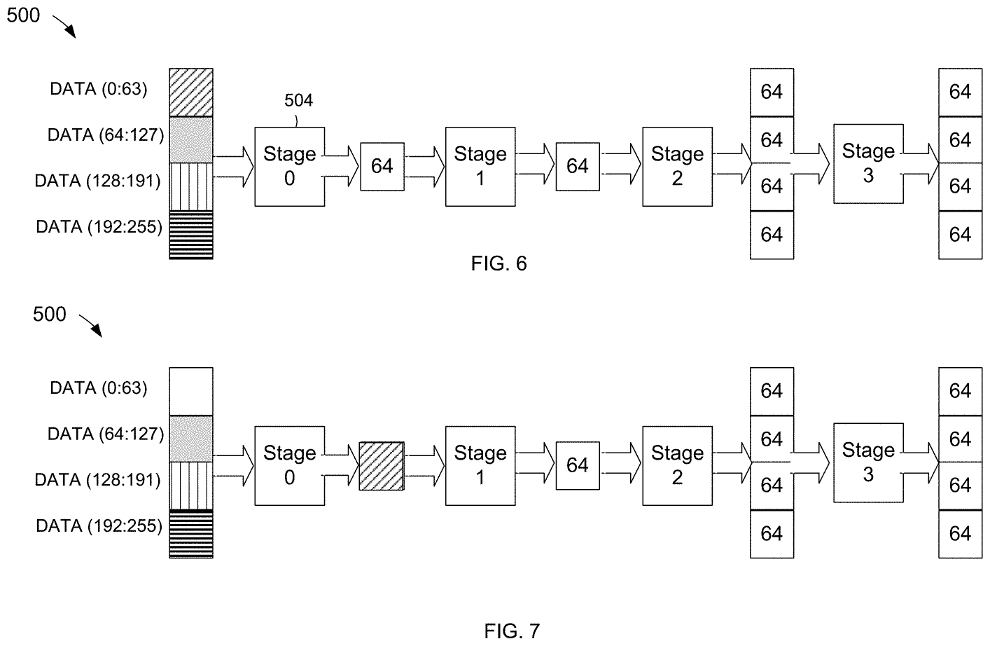

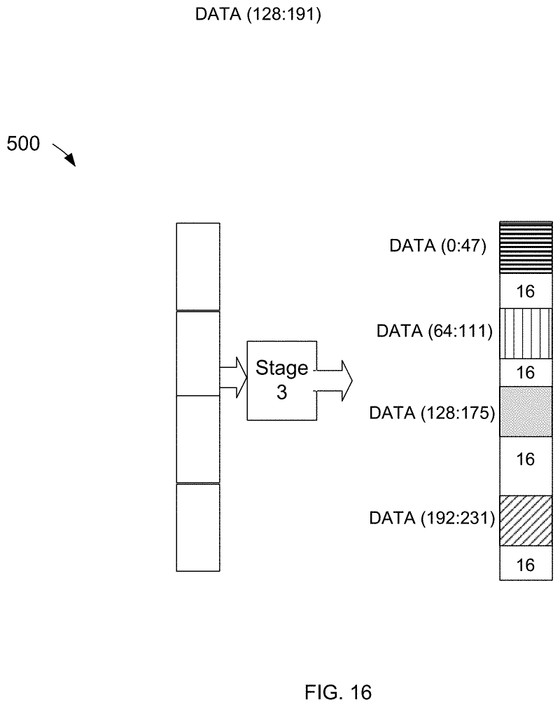

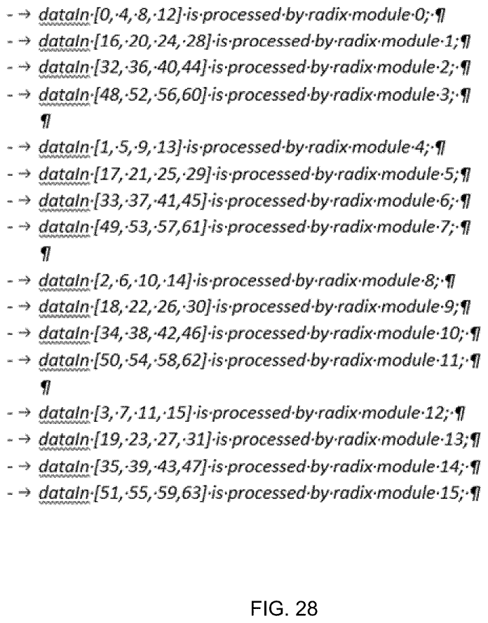

FIGS. 5 and 6 illustrate memory allocations in stages of an FFT process, in accordance with various embodiments of the subject technology. FIGS. 17-31 illustrate code for implementing an FFT process, in accordance with various embodiments of the subject technology. Further, FIGS. 5-16 illustrate the flow of data, dataflow, through the stages of the example FFT element, from data input, address mapping, pipelined stages, final stage and output. FIG. 16 illustrates the functional structure 500 having stages: Stage 0, 512, Stage 1,516, Stage 2, 520, and Stage 3, 522. Stage 0, 512, is coupled to the input receiving the remapped addressed as buffer 502 and a register 514 where computed outputs are stored. The buffer 502 include 4 sections of memory 504, 506, 508 and 510. Stage 1, 516, retrieves information from register 514 and stores the computed output in register 518, which data Stage 2, 520 retrieves. The computed output of Stage 2, 520, is organized into words 530 having 4 sections, 532, 534, 536 and 538. This information stored in words 530, which is a memory storage device such as a register, is input to Stage 3, which provides a computed output to buffer 540, also having 4 sections, 542, 544, 546, and 548. This structure of FFT stages, processing and output storage is repeated in the following example of dataflow through FIGS. 6-16.

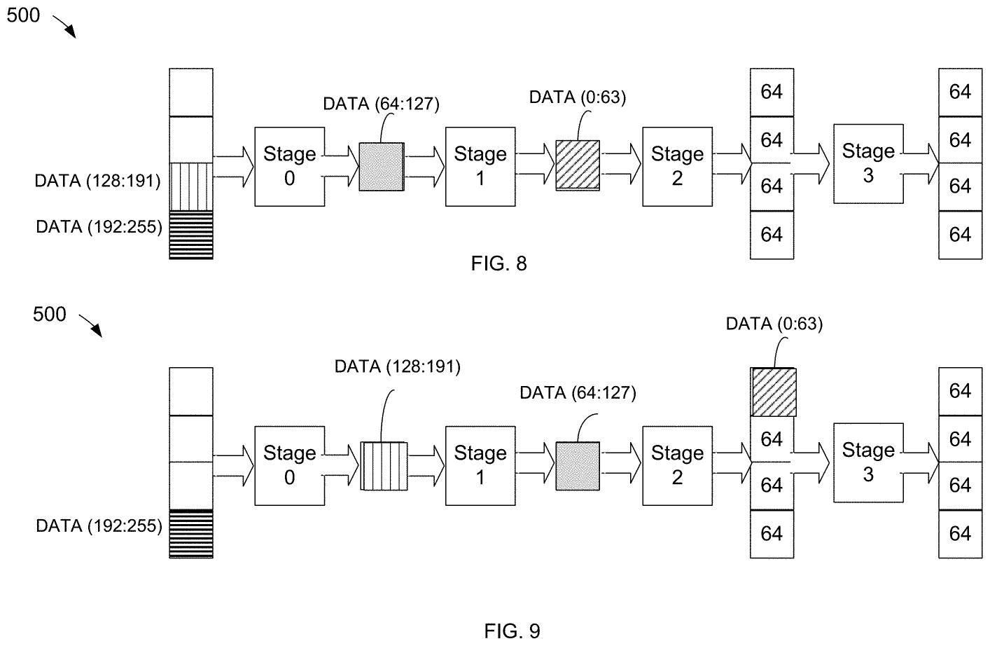

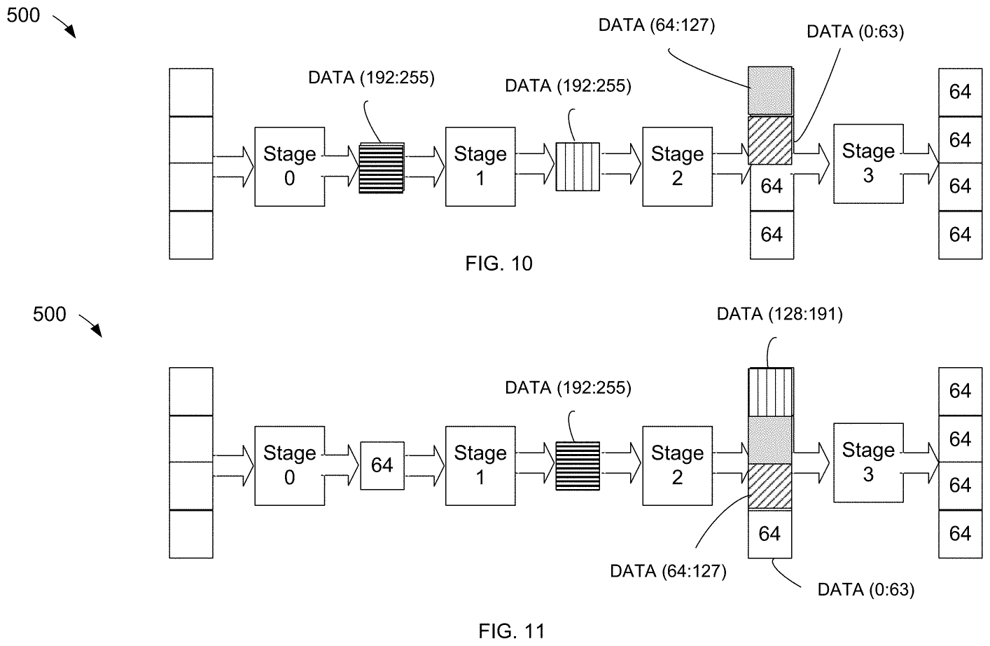

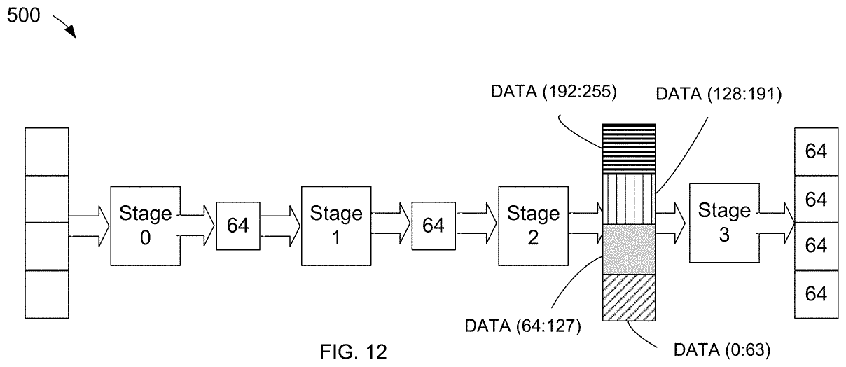

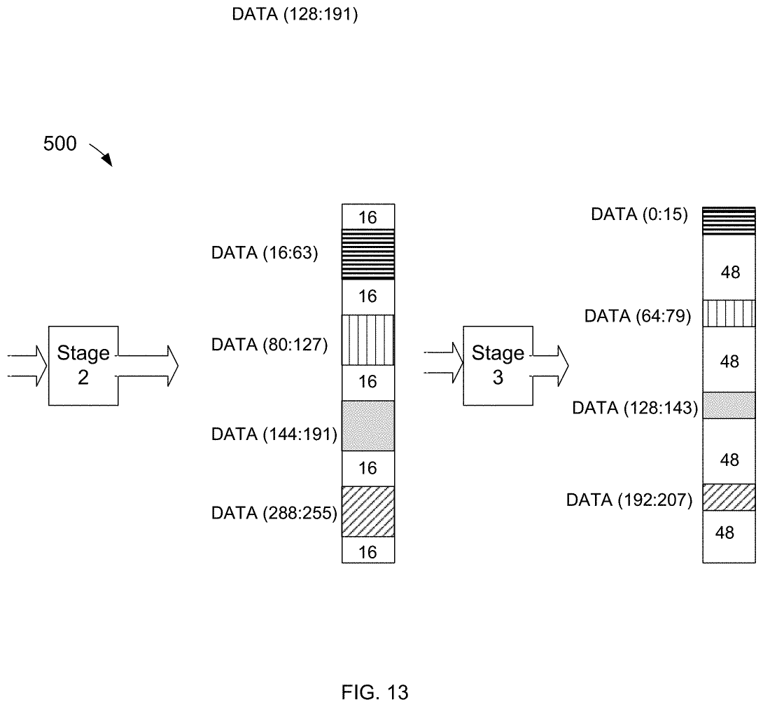

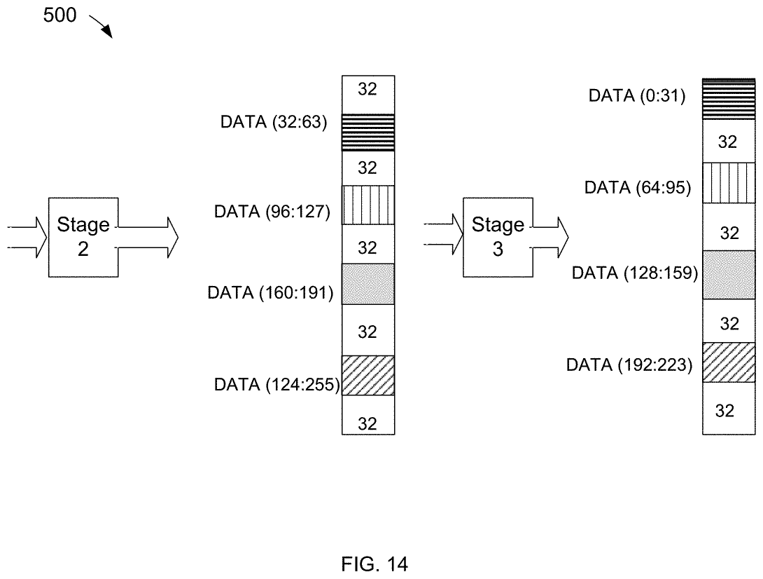

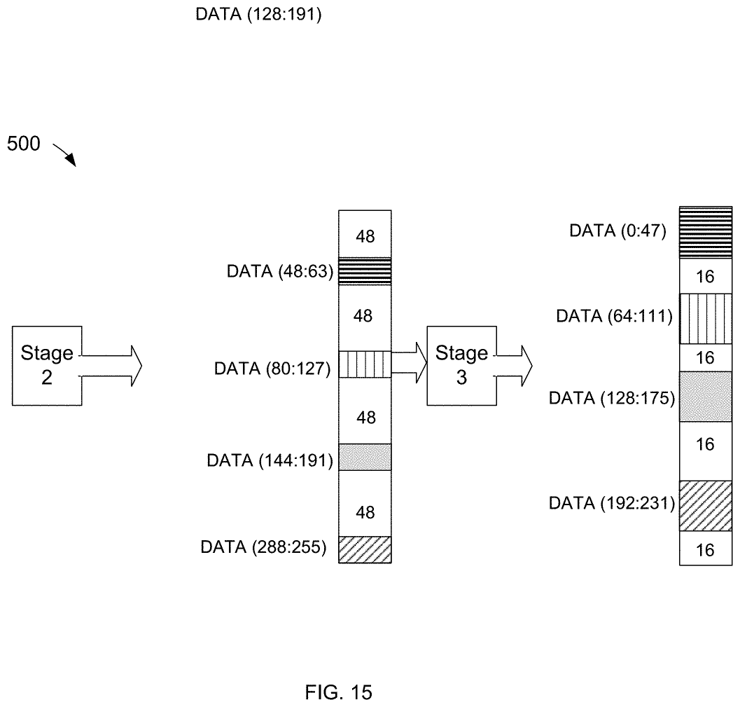

The processing begins with data provided from buffer 502, including the following: DATA (0:63) in location 504, DATA (62:127) in location 506, DATA (128:191) in location 508 and DATA (192:255) in location 510. For clarity, each section of buffer 502 has a different color or pattern to identify the flow of the original data through the process. In FIG. 7 processing begins as the first DATA (0:63) from section 504 is processed in Stage 0, 512 and the result is output to register 514. Continuing in FIG. 8 the DATA (0:63) is processed in Stage 1, 516, and output to register 518, while Data (63:127) is processed in Stage 0, 512, and output to register 514. This continues in FIG. 9 where the DATA (0:63) is processed in Stage 2, 520, and stored in section 532 of words 530. The following data information follows through this path. In FIGS. 10 and 11, the next process is to continue filling words 530 in the process order. In FIG. 12, the words 530 is full and Stage 3, 522, begins processing, and at this point the pipeline is broken. The next steps of the dataflow illustrate that 16 words of each 64 word portion are used to calculate the next 64 values; in this way 64 values are calculated at each step but the data is now mixed from across the entirety of 256 words. In FIG. 13, 16 words are processed for each DATA set and stored in buffer 540 as illustrated. At this point new data may be input into buffer 502 to start processing new data in parallel with a delay of 7 cycles. FIG. 14 illustrates processing of the next 16 words per DATA set which are stored in buffer 540 with the previous 16 words, resulting in 32 words of each DATA set in buffer 540. This continues through FIGS. 15 and 16, where all of the original DATA sets have been processed and the results stored in buffer 540.

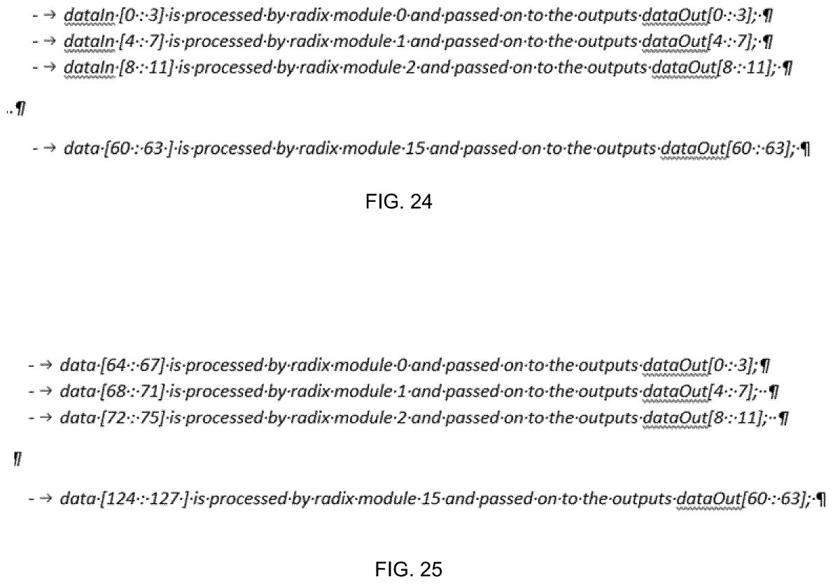

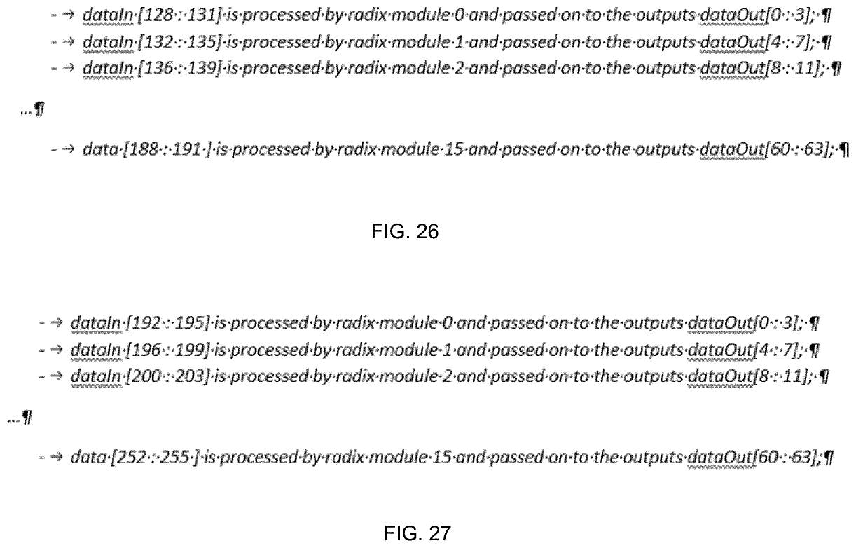

As discussed hereinabove and with respect to FIGS. 5-16, there are multiple stages to the FFT architecture and processing. Stage 0, 512, applies the address remapping format to identify 256 entries in buffer 502 and includes 16 radix-4 elements. The twiddle factor multiplication is defined as in FIG. 23. Starting with j=1, the lookupIndex for this Stage 0, 512, is zero, which translates into the first entry of the twiddle LUT, which is always 1.0. Therefore, a twiddle multiplier is not implemented for this stage. The incoming data is stored into 256 registers. 64 of the 256 complex registers are accessed in parallel such that 16 radix-4 elements can run in parallel. A two-bit control word selects from the 256 input words, or entries, for processing by the radix-4 elements. The 256 entries are divided into sets of 64 entries which are passed on through the FFT. Since the data is already organized correctly, a consecutive numbering scheme may be applied. There are 4 consecutive steps as illustrated in FIG. 24; after which 64 results pass to the next pipeline stage, Stage 1, 514, for processing. Nevertheless, in a second step of the first stage, illustrated in FIG. 25, the next 64 entries are processed using the same radix 4 elements. The same results are passed on to the next stage and subsequent stages process 64 values at a time, and not the full 256. To complete the process, the next step is performed as in FIG. 26, and a final step is performed as illustrated in FIG. 27. After the processing in Stage 0, 512, the data is passed into the pipeline and from this point the processing uses 16 radix-4 elements in parallel.

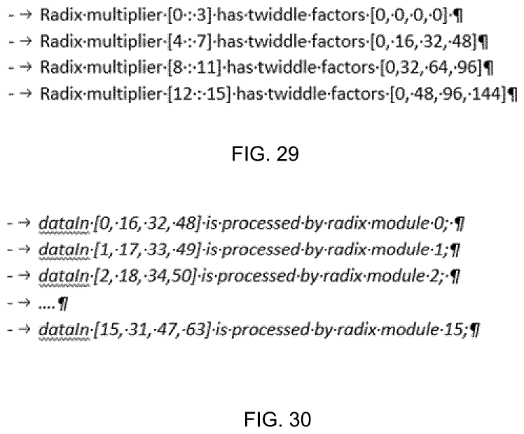

Stage 1, 514, receives 64 data elements at a time. The first step has the DATA[0:63] available, to process first. The following elements are processed using the 16 available radix-4 elements, the input and output indices are the same and therefore the distinction between dataIn and dataOut is omitted. The processing is illustrated in FIG. 27. The inputs here cover the 64 indices. In the next step, the same calculation is performed, whereas now the virtual indices are increased by 64. Although the physical indices span 0-63 the virtual indices now span 64-127. In the first step, the actual index of the data element and the virtual index are the same, specifically, where dataIn [0, 4, 8, 12] is processed by radix element 0 and passed to the output [0, 4, 8, 12]. Continuing with the processing, for the second step, the virtual dataIn [64, 68, 72, 76] are mapped to the physical data [0,4,8,12] and the output is put back to the physical locations [0,4,8,12]. The same is true for the third step where the virtual index [128, 132, 136, 140] is mapped to the physical index [0,4,8,12]; and in the fourth step the virtual index [191,196,200,204] is mapped to the physical index [0,4,8,12]. After 4 steps, the 256 values are calculated. Nevertheless, before each input enters the radix-4 multiplier it is multiplied with the twiddle factor. As the twiddle factors are calculated as described herein, the process refers simply to the indices of the twiddle factors. The twiddle factors are independent of the 4 steps; therefore, it may not be necessary to control them or change them when the data for the 4 steps is calculated. Specifically, the 64 twiddle factors may be reduced to ten as in FIG. 29. The twiddle factor with index 0 is relevant, although that does not imply an actual multiplier as that factor is 1.0. The twiddle factor with index 0 can be used for scaling purposes. The twiddle factors therefore can be fixed for this stage as they do not change with the 4 steps.

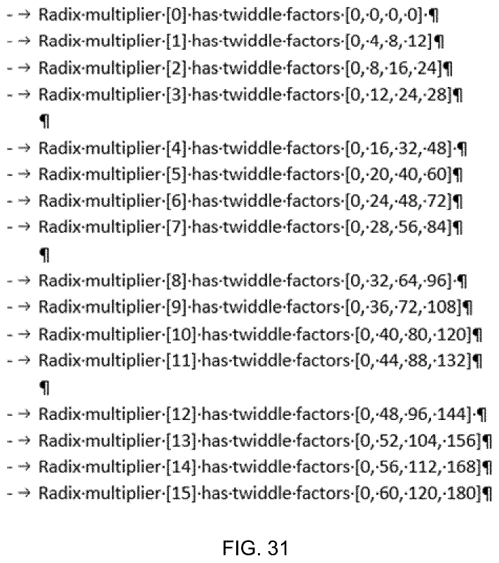

The Stage 2, 516, follows a similar principle as the first 64 elements are processed first so that the pipeline is not broken. This stage likewise incorporates the twiddle factor and the radix-4 stage. The first step is to calculate the parameters at the indices. The first step considers data with index 0-63, and is listed as in FIG. 30. As before, the twiddle indices are reused and apply throughout the 4 steps of this stage as illustrated in FIG. 31. The same processing applies as the twiddle factors are not changed during the 4 steps. The last stage, Stage 3, 518, is coordinated differently and effectively the pipeline is broken at this point. The data is collected before the final stage is performed and stored in buffer 530.

Stage 3, 518, is the last stage of the FFT and performs twiddle factor multiplication and the processing through the 16 radix-4 elements. This stage accesses the memory across the block of 64 registers. The twiddle factors for each radix-4 element is different.

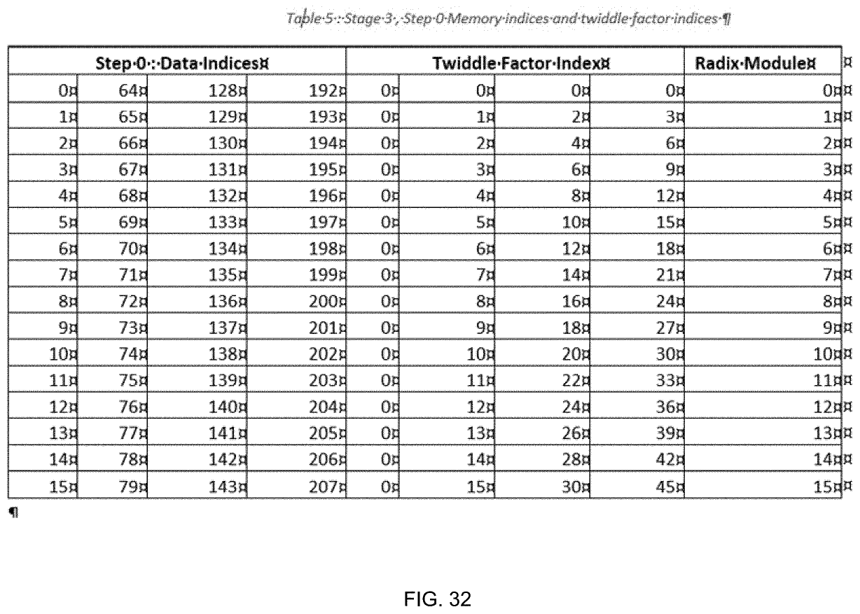

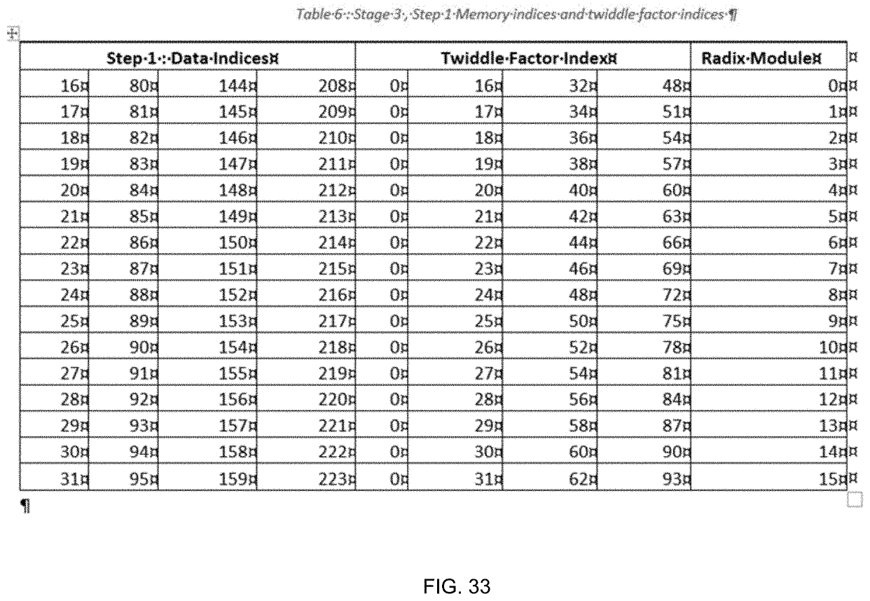

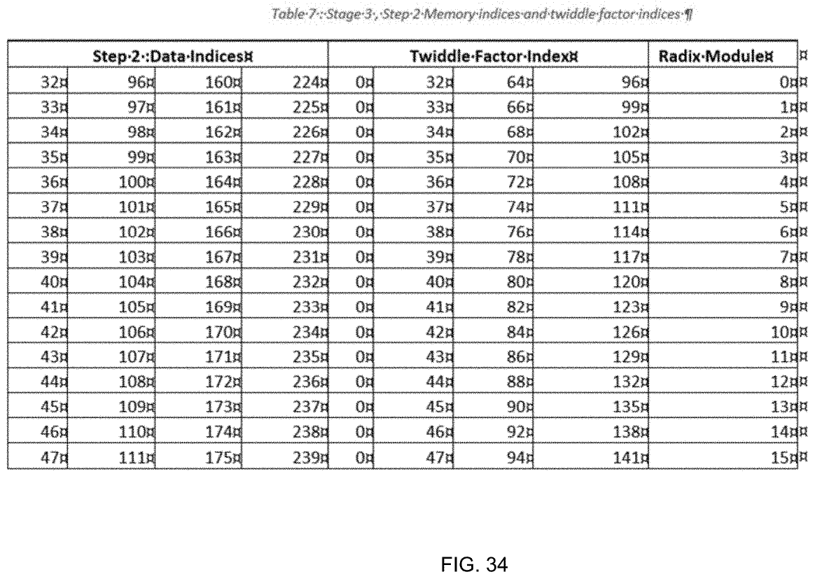

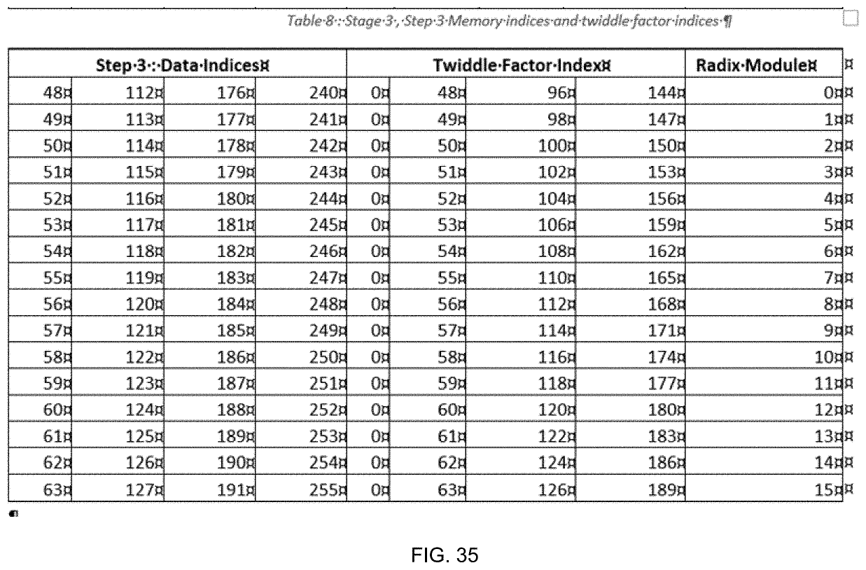

FIGS. 32-35 illustrate twiddle tables for an FFT process, in accordance with various embodiments of the subject technology. FIGS. 32-35 show tables of the twiddle factors and the mapping to the radix-4 elements for the cycles. The last stage is the most complex of the four stages as the process controls the twiddle factor based on each step of the 4 steps. The complexity can be mitigated by reducing the number of radix-4 elements, which nevertheless would still increase the complexity of the twiddle factor memory access. In the present embodiment, the full twiddle factor table is not used. The complete pipeline output is stored in a 256-memory array for further access.

The disclosure presented herein provide solutions that balance hardware complexity and throughput speed. The FFT presented herein uses radix-4 based architecture where 16 radix-4 elements are implemented per stage in a pipelined structure with localized twiddle factor tables.

The use of radix-4 elements in place of radix-2 elements, using a reduced four stages rather than 8. The number of radix-4 operations is 64 per each stage of a pipeline, compared to 128 needed for radix-2 implementations. The total number of operations is 256, whereas a radix-2 implementation would require 512 radix-2 operations. Although the radix-4 element is more complex, in balance there are less components and a radix-4 solution uses less memory for interim results.

The number of physical radix-4 elements is reduced to 16 per each stage, which means that each stage performs 4 steps. Nevertheless, due to the organization and the selection of the indices, each radix-4 element is fully engaged at all times. This leads to optimized throughput with low overhead given the use of 16 radix-4 elements. Many other implementations do not fully use the available hardware as they require data reorganization steps in between stages. In the present disclosure, the description of each stage shows how the data indices are organized so that 64 points are calculated without delay in the 3 first stages. The last stage breaks the pipeline but also not significantly.

The twiddle factor tables are localized and adapted for each stage, which means that a fully pipelined solution is possible. The required twiddle factors are provided at each stage and therefore no overhead is generated by maintaining a complete twiddle factor table. By organizing the data appropriately, twiddle factors are not changing from one step to the next and the last step is different in that regard.

Once the data is in an input buffer 502, it takes 10 cycles, or steps, to complete the FFT process, which is a fast solution in the automotive industry and others. Since it is pipelined already, after 7 cycles the next FFT may start its operation. To allow the pipeline to restart after 4 cycles, a double buffer may be placed at the interim stage, which is setup as ping-pong buffer. While a stage 2 is writing to one buffer, a stage 3 is reading from the other buffer and this may avoid 3 cycle delay.

The FFT algorithms presented herein are well suited for an ASIC or field programmable gate array (FPGA) implementation. The number of stages is calculated as a logarithm of base-4 and therefore may be implemented in 4 stages for a full 256 FFT. The herein proposed solution has 16 radix-4 elements in each stage. Due to the data organization the first 3 stages may be performed in a perfect pipelined manner. The fourth stage breaks from the pipeline system while maintaining the process in 10 cycles. After just 7 cycles, the next FFT process may start. This system is optimized for radar related work where two or even more FFT processes are performed consecutively. A higher resolution in time is achieved by the use of such an FFT.

FIG. 36 illustrates a radar system 3600 for detecting an automobile 3610. The radar system 3600 having receive and transmit antennas coupled to transceiver 3608. On the transmit path, a signal generator 3602 is coupled to a voltage-controlled oscillator (VCO) 3604 and the transceiver 3608. The receive path coupled the transceiver 3608 to an analog to digital converter (ADC) 3608 and digital processing 3606. The digital processing includes FFT element 3660 which may incorporate the FFT methods and apparatuses of the present disclosure. The FFT element 3660 identifies reflected signals from targets and compares the gain, unit 3662, of these reflected signals to a threshold, unit 3666, leading to target detection, unit 3664. In such a system the ability to detect objects in the path of a vehicle real time is paramount. The solutions presented herein optimize digital processing time and therefore improve performance and reliability of the system 3600.

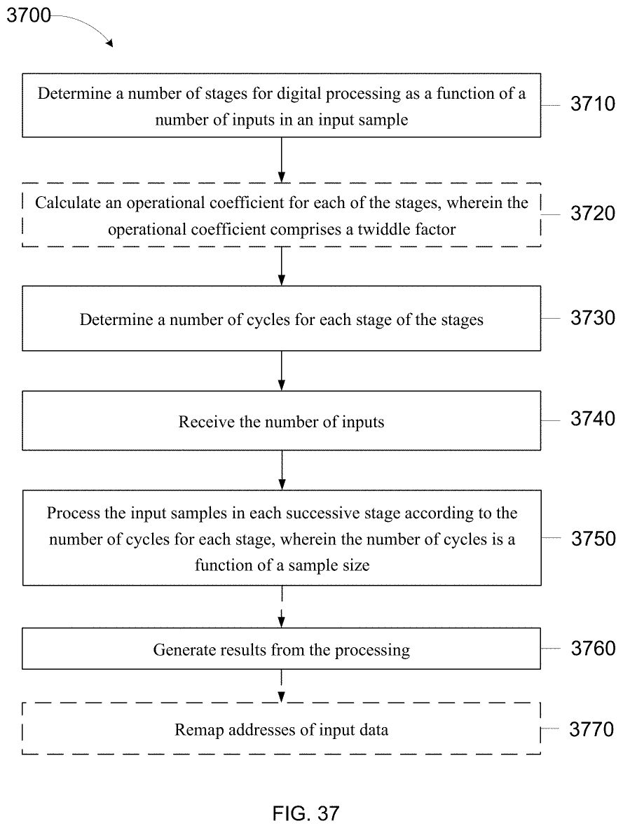

FIG. 37 illustrates a flowchart for an example method of using an FFT process, in accordance with one or more implementations of the subject technology. As illustrated in FIG. 37, the example method is a digital processing method 3700, which includes, at step 3710, determining a number of stages for digital processing as a function of a number of inputs in an input sample. The digital processing method 3700 optionally includes, at step 3720, calculating an operational coefficient for each stage, wherein the operational coefficient comprises a twiddle factor. The digital processing method 3700 includes, at step 3730, determining a number of cycles for each stage of the stages; at step 3740, receiving the number of inputs; at step 3750, processing the input samples in each successive stage according to the number of cycles for each stage, wherein the number of cycles is a function of a sample size; and/or at step 3760, generating results from the processing.

In various embodiments, the digital processing method is a Fast Fourier Transform (FFT) processing. In various embodiments, the twiddle factor is a trigonometric constant. In various embodiments, digital processing method 3700 optionally includes remapping addresses of input data.

In accordance with various embodiments, a radar system is disclosed in detail. The radar system may include a transceiver. The radar system may include an analog to digital converter (ADC); a digital processing unit coupled to the ADC. The digital processing unit may include a plurality of Fast Fourier Transform (FFT) elements and a plurality of memory storage devices coupled to the plurality of FFT elements. The plurality of FFT elements and the plurality of memory storage devices are configured in a pipeline. The radar system may include a twiddle factor table comprising a plurality of twiddle factors, wherein each twiddle factor of the plurality of twiddle factors corresponds to an FFT element in the plurality of FFT elements. The radar system may include a control unit coupled to the digital processing unit and configured to control each of the plurality of FFT elements a predetermined number of times.

In various embodiments, the radar system may include an address remapping unit configured to digit reverse input indices. In various embodiments, at least a portion of the plurality of FFT elements are base 4 elements. In various embodiments, the pipeline comprises four stages, each stage comprising four FFT elements, wherein each FFT element is cycled four times to generate an output.

In various embodiments, at least one twiddle factor of the twiddle factor table is a multiplier in FFT processing. In various embodiments, the plurality of FFT elements process data iteratively. In various embodiments, the plurality of memory storage devices includes a set of registers. In various embodiments, an input to the pipeline is provided in increments. In various embodiments, a final stage of the pipeline accesses multiple increments. In various embodiments, a number of FFT elements in the plurality of FFT elements is a function of a radar sample size.

In accordance with various embodiments, a digital processing system is provided. The digital processing system may include a plurality of stages of processing elements configured in a sequence, wherein a number of stages is a function of a number of inputs and the plurality of stages form a processing pipeline; a plurality of memory storage devices coupled to each stage of the plurality of stages, the memory storage devices adapted to store interim results; a final stage of processing elements configured to combine outputs from the sequence of stages; and/or a controller adapted to iteratively process data through the processing elements.

In various embodiments, the digital processing system may include a lookup table coupled to the controller, the lookup table storing a plurality of operational coefficients comprising twiddle factors. In various embodiments, the lookup table stores the twiddle factors corresponding to each stage of the plurality of stages. In various embodiments, the digital processing system may include an address remapping module coupled to the plurality of stages. In various embodiments, each stage of the plurality of stages includes radix-4 FFT elements.

In accordance with various embodiments, a digital processing method is disclosed. The digital processing method may include determining a number of stages for digital processing as a function of a number of inputs in an input sample; determining a number of cycles for each stage of the stages; receiving the number of inputs; processing the input samples in each successive stage according to the number of cycles for each stage, wherein the number of cycles is a function of a sample size; and/or generating results from the processing.

In various embodiments, the digital processing method is a Fast Fourier Transform (FFT) processing. In various embodiments, prior to determining the number of cycles for each of the stages, the digital proceed method may include calculating an operational coefficient for each stage, wherein the operational coefficient comprises a twiddle factor. In various embodiments, the twiddle factor is a trigonometric constant. In various embodiments, the digital proceed method may include remapping addresses of input data.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A radar system, comprising:
an analog to digital converter (ADC);
a digital processing unit coupled to the ADC, the digital processing unit comprising:
a plurality of Fast Fourier Transform (FFT) elements; and
a plurality of memory storage devices coupled to the plurality of FFT elements,
wherein the plurality of FFT elements and the plurality of memory storage devices are configured in a pipeline; and
a twiddle factor table comprising a plurality of twiddle factors, wherein each twiddle factor of the plurality of twiddle factors corresponds to an FFT element in the plurality of FFT elements.

2. The radar system of claim 1, further comprising:
a control unit coupled to the digital processing unit and configured to control each of the plurality of FFT elements a predetermined number of times.

3. The radar system of claim 1, further comprising:
an address remapping unit configured to digit reverse input indices.

4. The radar system of claim 1, wherein at least a portion of the plurality of FFT elements are base 4 elements.

5. The radar system of claim 1, wherein the pipeline comprises four stages, each stage comprising four FFT elements, wherein each FFT element is cycled four times to generate an output.

6. The radar system of claim 1, wherein at least one twiddle factor of the twiddle factor table is a multiplier in FFT processing.

7. The radar system of claim 1, wherein the plurality of FFT elements process data iteratively.

8. The radar system of claim 1, wherein the plurality of memory storage devices includes a set of registers.

9. The radar system of claim 1, wherein an input to the pipeline is provided in increments.

10. The radar system of claim 9, wherein a final stage of the pipeline accesses multiple increments.

11. A digital processing system, comprising:
a plurality of stages of processing elements configured in a sequence, wherein a number of stages is a function of a number of inputs and the plurality of stages form a processing pipeline;
a plurality of memory storage devices coupled to each stage of the plurality of stages, the memory storage devices adapted to store interim results;
a final stage of processing elements configured to combine outputs from the sequence of stages; and
a controller adapted to iteratively process data through the processing elements.

12. The digital processing system of claim 11, further comprising:
a lookup table coupled to the controller, the lookup table storing a plurality of operational coefficients comprising twiddle factors.

13. The digital processing system of claim 12, wherein the lookup table stores the twiddle factors corresponding to each stage of the plurality of stages.

14. The digital processing system of claim 13, further comprising:
an address remapping module coupled to the plurality of stages.

15. The digital processing system of claim 14, wherein each stage of the plurality of stages includes radix-4 FFT elements.

16. A digital processing method, comprising:
determining a number of stages for digital processing as a function of a number of inputs in an input sample;
determining a number of cycles for each stage of the stages;
receiving the number of inputs;
processing the input samples in each successive stage according to the number of cycles for each stage, wherein the number of cycles is a function of a sample size; and
generating results from the processing.

17. The method of claim 16, wherein the digital processing method is a Fast Fourier Transform (FFT) processing.

18. The method of claim 17, further comprising:
prior to determining the number of cycles for each stage, calculating an operational coefficient for each of the stages, wherein the operational coefficient comprises a twiddle factor.

19. The method of claim 18, wherein the twiddle factor is a trigonometric constant.

20. The method of claim 16, further comprising:
remapping addresses of input data.
